(19) United States
(12) Patent Application Publication
(10) Pub. No.: US 2016/0373376 A1
(43) Pub. Date: Dec. 22, 2016

(54) METHOD AND APPARATUS OF PLAYING CONTENTS SEAMLESSLY

(71) Applicant: Samsung Electronics Co., Ltd., Gyeonggi-do (KR)

(72) Inventors: Jin-hyeong AHN, Jeollanam-do (KR); Sangjeong Lee, Gyeonggi-do (KR); Kyung-ah Chang, Seoul (KR)

(73) Assignee: Samsung Electronics Co., Ltd.

(21) Appl. No.: 15/253,145

(22) Filed: Aug. 31, 2016

Related U.S. Application Data
(63) Continuation of application No. PCT/KR2016/002205, filed on Mar. 4, 2016.

(30) Foreign Application Priority Data
Apr. 1, 2015 (KR) 10-2015-0046194

(51) Int. Cl. H04L 12/911; H04N 21/442; H04N 21/414; H04N 21/41; H04L 29/08; H04N 21/436

(52) U.S. Cl. CPC H04L 47/821; H04L 67/10; H04L 67/327; H04N 21/43615; H04N 21/41407; H04N 21/4131; H04N 21/44218; H04N 21/44227

(57) ABSTRACT

A method of reproducing content seamlessly, the method includes: determining an operation state of registered devices; receiving information regarding an application that is being executed or has been executed by a registered device in operation from among the registered devices; determining a priority of reproducible content based on the information regarding the application; and reproducing content having a first priority from among the content.

### PRIORITY

This application is a Continuation of PCT/KR2016/002205, filed Mar. 4, 2016, and claims the benefit of Korean Patent Application No. 10-2015-0046194, filed on Apr. 1, 2015, in the Korean Intellectual Property Office, the disclosure of which is incorporated herein in its entirety by reference.

### TECHNICAL FIELD

The inventive concept relates to a method and an apparatus for reproducing content.

### BACKGROUND ART

As various content are distributed, apparatuses that may reproduce content are produced. A digital TV, a computer, a notebook computer, a mobile phone, a tablet personal computer (PC), etc. may reproduce various content. A user may possess only one device but may possess a plurality of devices. Also, the user may appreciate content while moving in a space. Seamless play denotes that a plurality of devices possessed by a user reproduces the same content seamlessly. The plurality of devices may share content and reproduce the shared content.

### DETAILED DESCRIPTION OF THE INVENTIVE CONCEPT

### Technical Problem

The inventive concept provides methods and apparatuses for reproducing content seamlessly.

### Technical Solution

According to an aspect of the inventive concept, there is provided a method of reproducing content seamlessly, the method including: determining an operation state of registered devices; receiving information regarding an application which is being executed or which has been executed by a registered device in operation from among the registered devices; determining a priority of reproducible content based on the information regarding the application; and reproducing content having a first priority from among the content.

According to another aspect of the inventive concept, there is provided a device for reproducing content seamlessly, the device including: a memory; and a processor, wherein the processor determines an operation state of registered devices, receives information regarding an application which is being executed or which has been executed by a registered device in operation from among the registered devices, determines a priority of reproducible content based on the information regarding the application, and reproduces content having a first priority from among the content.

### DESCRIPTION OF THE DRAWINGS

FIG. 1 illustrates a method of reproducing content seamlessly between a plurality of devices.

FIG. 2 is a view illustrating a method of determining content to be reproduced by a device.

FIG. 3 is a flowchart for explaining a method of reproducing content seamlessly in a device according to an embodiment.

FIG. 4 is a block diagram of a configuration of a device according to an embodiment.

FIG. 5 is a flowchart for explaining a method of reproducing content seamlessly according to an embodiment.

FIG. 6 is a flowchart for explaining a method of reproducing content seamlessly according to an embodiment.

### BEST MODE

According to an aspect of the inventive concept, there is provided a method of reproducing content seamlessly, the method including: determining an operation state of registered devices; receiving information regarding an application which is being executed or which has been executed by a registered device in operation from among the registered devices; determining a priority of reproducible content based on the information regarding the application; and reproducing content having a first priority from among the content.

According to another aspect of the inventive concept, there is provided a device for reproducing content seamlessly, the device including: a memory; and a processor, wherein the processor determines an operation state of registered devices, receives information regarding an application which is being executed or which has been executed by a registered device in operation from among the registered devices, determines a priority of reproducible content based on the information regarding the application, and reproduces content having a first priority from among the content.

### MODE OF THE INVENTIVE CONCEPT

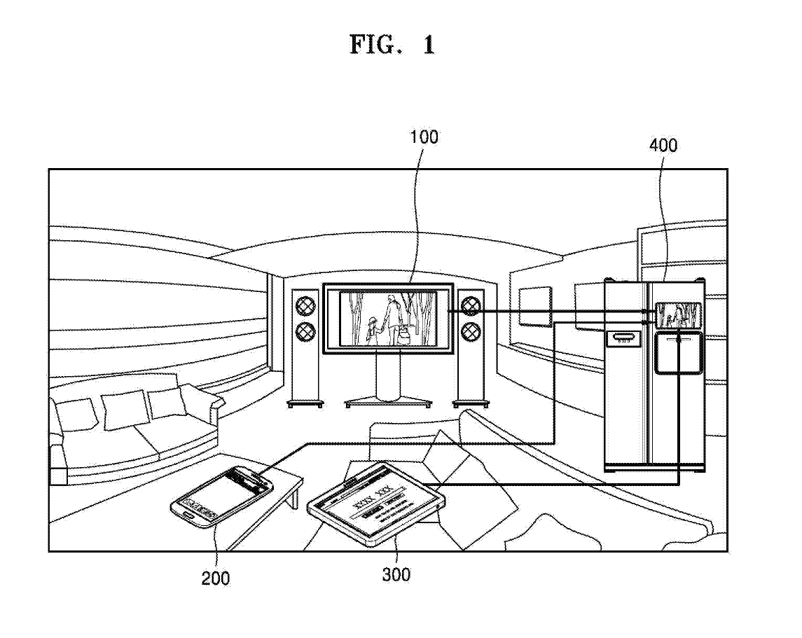

FIG. 1 illustrates a method of reproducing content seamlessly between a plurality of devices. Referring to FIG. 1, the plurality of devices may reproduce content seamlessly without a separate input. For example, when a user moves near a refrigerator 400 while viewing a TV 100, the refrigerator 400 may reproduce the content which is being reproduced by the TV 100. Therefore, the user who has viewed the TV 100 continues to view the content. When the user approaches the refrigerator 400, the refrigerator 400 detects an on/off state of registered devices, and receives information regarding applications from devices in operation. The refrigerator 400 may automatically reproduce one of various content even without a user's input by determining content of a device to reproduce and reproducing the content according to a set priority.

FIG. 1 illustrates the case where devices registered by a user are the TV 100, a mobile phone 200, a tablet personal computer (PC) 300, and the refrigerator 400. The user may register devices owned by himself. The registered devices may transmit/receive data to/from each other in order to share content. Like other devices, the refrigerator 400 may display an image by including a display, or reproduce music by using a speaker.

Though FIG. 1 illustrates the TV 100, the mobile phone 200, the tablet PC 300, the refrigerator 400, etc., a notebook computer, a desktop computer, etc. may be registered by a user and may share content with other devices.

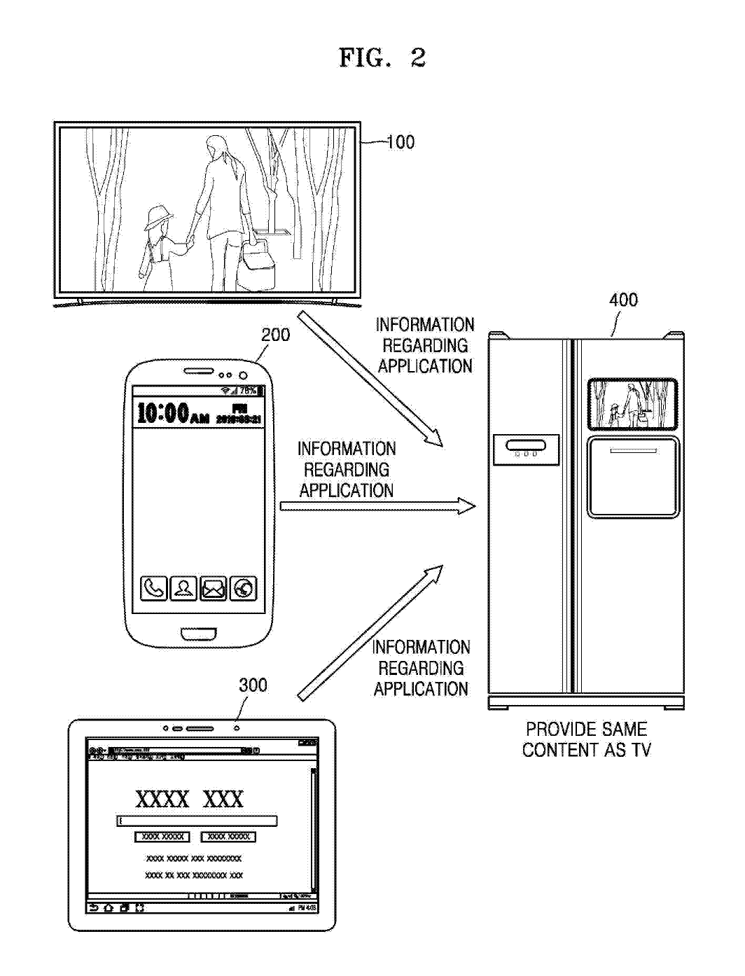

FIG. 2 is a diagram for explaining a method of determining content to be reproduced by a device. Referring to FIG. 2, the refrigerator 400 receives information regarding an application from at least one of the TV 100, the mobile phone 200, and the tablet PC 300, and determines content to reproduce based on the received information regarding the application.

The refrigerator 400 detects that a user approaches the refrigerator 400 and requests the TV 100, the mobile phone 200, and the tablet PC 300 connected via a wired line or wirelessly to transmit the information regarding the application. The TV 100, the mobile phone 200, and the tablet PC 300 transmit the information regarding the application to the refrigerator 400. The information regarding the application is information regarding an application which is being executed by the TV 100, the mobile phone 200, the tablet PC 300, etc., information regarding content that has been reproduced, and information regarding a time when the application has been reproduced. For example, the TV 100 may transmit information that a drama is being currently reproduced by using a media player to the refrigerator 400. The mobile phone 200 may transmit information that music was reproduced one hour before by using a media player to the refrigerator 400. The tablet PC 300 may transmit information that a portal site was displayed ten minutes before by using an Explorer (a program for accessing the Internet) to the refrigerator 400.

The refrigerator 400 determines content to reproduce based on the received information regarding the application. The information regarding the application includes a kind of devices, a kind of an application, a kind of content, a time when an application has been executed, etc. The refrigerator 400 may determine content to reproduce based on a combination of at least two or more of the kind of devices, the kind of an application, the kind of content, and the time when an application has been executed. For example, the refrigerator 400 may determine content to reproduce based on the kind of devices and the time when an application has been executed.

The devices 100 to 400 may detect a user's access via various methods. For example, the devices 100 to 400 may detect that a user approaches the devices 100 to 400 via a wearable device worn by the user. The devices 100 to 400 may track the location of a wearable device via wireless communication, a global positioning system (GPS), etc. The devices 100 to 400 track the location of a wearable device and detects that the wearable device approaches the devices 100 to 400. The wearable device denotes a device such as a smart-watch that may be worn on a user's body. Alternatively, the devices 100 to 400 may detect a user's access by using various sensors. The devices 100 to 400 may detect a user's access by using an ultraviolet sensor, a camera, etc. The devices 100 to 400 may detect a user's access by detecting a user's body temperature, a user's eye, etc.

Though FIG. 2 has described a case where the refrigerator 400 receives information regarding an application from the TV 100, the mobile phone 200, the tablet PC 300, etc., in the case where a user approaches the tablet PC 300, the refrigerator 400, the TV 100, and the mobile phone 200 transmit information regarding an application to the tablet PC 300.

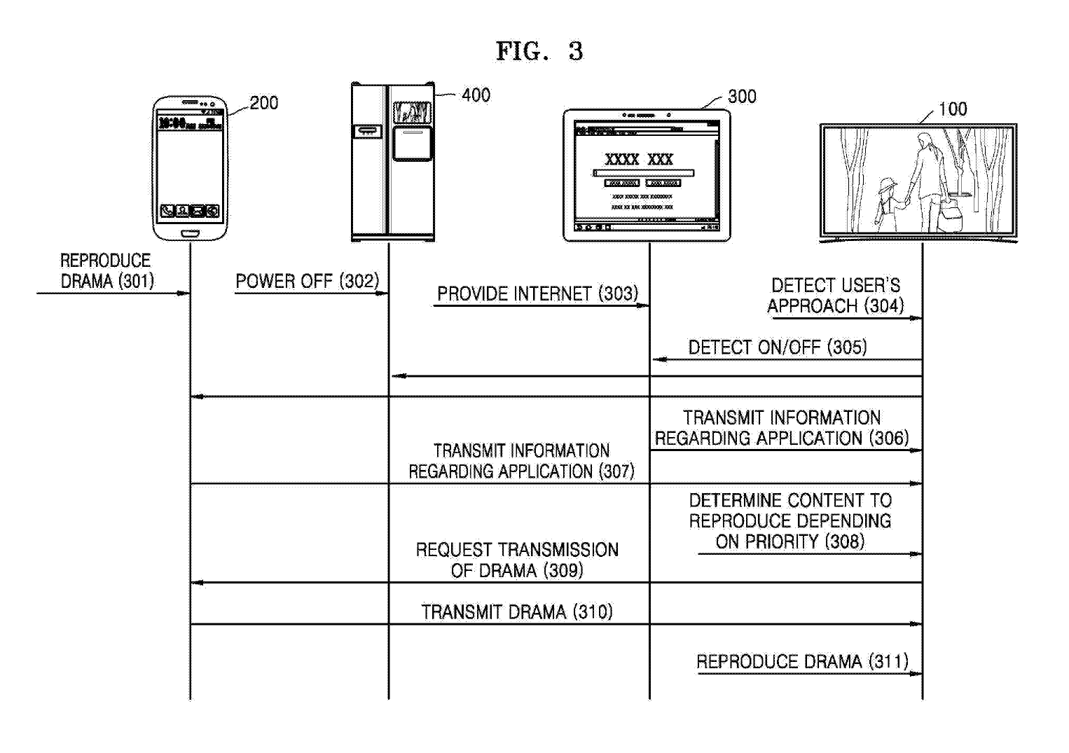

FIG. 3 is a flowchart for explaining a method of reproducing content seamlessly in a device according to an embodiment. Referring to FIG. 3, the TV 100 may reproduce seamlessly a drama reproduced by the mobile phone 200. Since the TV 100 detects a user's access and automatically reproduces content having a first priority depending on a priory, the TV 100 may reproduce content seamlessly even without a user's manipulation.

In operation 301, the mobile phone 200 reproduces a drama by using a media player. In operation 302, the refrigerator 400 is turned off. In operation 303, the tablet PC 300 provides the Internet by using an Explorer.

In operation 304, the TV 100 detects a user's access. The TV 100 determines whether the user approaches within a set range from the TV 100.

In operation 305, the TV 100 determines an operation state of registered devices. The operation state denotes on/off-states of the registered devices. The registered devices denote devices possessed by the user.

In operation 306, the tablet PC 300 transmits information regarding an application to the TV 100. The tablet PC 300 transmits information regarding an application which is currently being executed or which has been executed previously. For example, in the case where the tablet PC 300 is currently providing the Internet, the tablet PC 300 transmits an address of a site currently displayed on a screen to the TV 100. Also, in the case where the tablet PC 300 is reproducing music, the tablet PC 300 transmits information regarding the music being reproduced and the location of the currently reproduced music to the TV 100. In the case where the tablet PC 300 has displayed a photo previously, the tablet PC 300 transmits information regarding the photo to the TV 100.

In operation 307, the mobile phone 200 transmits information regarding an application to the TV 100. Like the tablet PC 300, the mobile phone 200 transmits the information regarding the application which is currently being executed or which has been executed previously.

In operation 308, the TV 100 determines content to reproduce depending on a priority. The TV 100 determines content to reproduce based on the information regarding the application received from the mobile phone 200 and the tablet PC 300. The TV 100 sets a reference for determining the priority in advance and determines the priority of content based on the set reference and the received information regarding the application. For example, the TV 100 may set the priority depending on a kind of an application which is being executed or which has been executed. The TV 100 sets the priorities in the order of a media player, an Explorer, a phone, etc. Since the mobile phone 200 has been executing the media player, and the tablet PC 300 has been executing the Explorer, the priority of the mobile phone 200 is higher. Therefore, the TV 100 may determine a drama, which is content being reproduced by the mobile phone 200, as content to reproduce.

In operation 309, the TV 100 requests the mobile phone 200 to transmit the drama. Since the TV 100 has determined the drama, which is being reproduced by the mobile phone 200, as content to reproduce, the TV 100 requests the mobile phone 200 to transmit the drama currently being reproduced, or transmit information regarding the drama.

In operation 310, the mobile phone 200 transmits the drama to the TV 100. The mobile phone 200 may transmit the information regarding the drama to the TV 100. The information regarding the drama may be a title of the drama, a channel of the drama, etc.

In operation 311, the TV 100 reproduces the drama. In the case of receiving the drama in the form of a file from the mobile phone 200, the TV 100 reproduces the received file. Also, in the case of receiving the information regarding the drama, the TV 100 reproduces the drama of the received channel.

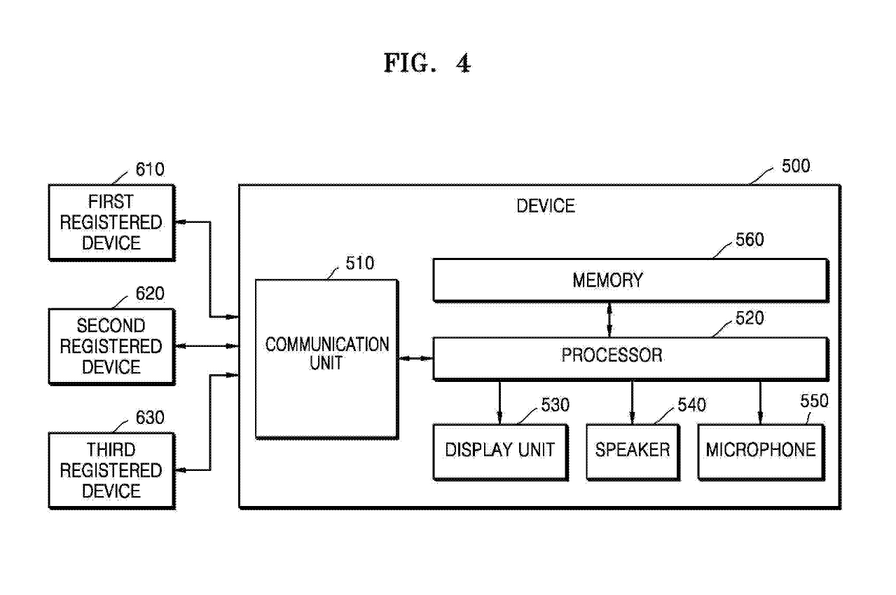

FIG. 4 is a block diagram of a configuration of a device 500 according to an embodiment. Referring to FIG. 4, the device 500 includes a communication unit 510, a processor 520, a display unit 530, a speaker 540, and a microphone 550. In FIG. 4, the device 500 reproduces content and includes the display unit 530, the speaker 540, the microphone 550, etc., but the device 500 may include at least one of the display unit 530, the speaker 540, and the microphone 550. Also, the device 500 may further include a configuration that may reproduce content in addition to the display unit 530, the speaker 540, and the microphone 550.

Reproducing content denotes operations in which the device 500 reproduces a movie, reproduces a drama, reproduces music, displays a message, or outputs voice, etc. Also, the device 500 may receive a user's voice by using the microphone 550 and transmit the voice to a mobile phone of a counterpart user with whom the user has been communicating.

First to third registered devices 610 to 630 are devices used by the same user. The device 500 registers the first to third registered devices 610 to 630 in advance and is connected to the first to third registered devices 610 to 630 via a wired line or wirelessly.

The communication unit 510 transmits/receives data to/from the first to third registered devices 610 to 630. The communication unit 510 outputs received data to the processor 520 and transmits data received from the processor 520 to the first to third registered devices 610 to 630.

The processor 520 determines an operation state of the registered devices. The processor 520 determines an on/off-state of the first to third devices 610 to 630 via the communication unit 510.

The processor 520 receives, from a registered device in operation, information regarding an application which is being executed or which has been executed by the registered device in operation from among the first to third registered devices 610 to 630. The registered device in operation denotes a registered device whose power has been turned on. The application which is being executed denotes a program, etc. which are currently being executed by the first to third registered devices 610 to 630. The application which has been executed denotes a program, etc. which have been executed previously by the first to third registered devices 610 to 630.

The processor 520 determines a priority of reproducible content based on information regarding an application. The processor 520 may determine a priority of content depending on a kind of the registered devices. For example, in the case where priorities are determined in the order of a TV, a mobile phone, a tablet PC, a notebook computer, and a refrigerator, and only the tablet PC and the notebook computer are in operation, the processor 520 may determine that the priority of content which is being reproduced by the tablet PC is higher than the priority of content which is being reproduced by the notebook computer.

The processor 520 may determine the priority of content depending on a kind of an application. For example, in the case where priorities are determined in the order of a phone, a short message service (SMS), broadcasting, a media player, and an Explorer, and applications which are being executed or which have been executed are the media player and the Explorer, the processor 520 may determine that the priority of content which is being reproduced by the media player is higher than the priority of content which is being displayed by the Explorer.

The processor 520 may determine the priority of content depending on a kind of content. For example, in the case where priorities are determined in the order of a drama, a movie, music, and the Internet, and the drama and the music are being reproduced, the processor 520 may determine that the priority of the drama is higher than the priority of the music.

The processor 520 may determine the priority of content depending on a time when an application has been executed. For example, in the case where applications which is being executed or which has been executed by the registered devices are a phone, an SMS, broadcasting, a media player, the processor 520 may determine a priority of applications in the order in which the applications have been executed most recently.

The processor 520 may determine a priority of content by combining two or more of a kind of the registered devices, a kind of the applications, a kind of content, and a time when the applications have been executed. For example, the processor 520 may determine a priority of content by taking into account a kind of the content and a time when the applications have been executed. Assuming that the TV is reproducing a movie and the mobile phone reproduced a movie one hour before, since the TV is currently reproducing the movie, the processor 520 may determine that the priority of the movie being reproduced by the TV is higher than the priority of the movie which was reproduced by the mobile phone.

The processor 520 reproduces content having a first priority from among content. The processor 520 may reproduce the content by controlling the display unit 530, the speaker 540, or the microphone 550, etc. Also, in the case where reproducible content are two or more, the processor 520 may display a list of the content on the display unit 530, receive an input from a user, and reproduce content selected by the user.

In the case where the user gets out of a set range, the processor 520 may stop reproducing content. In other words, in the case where the user deviates from the device 500, since the device 500 does not need to reproduce content any more, the device 500 stops reproducing. In this case, another device which has detected that the user approaches may reproduce content seamlessly.

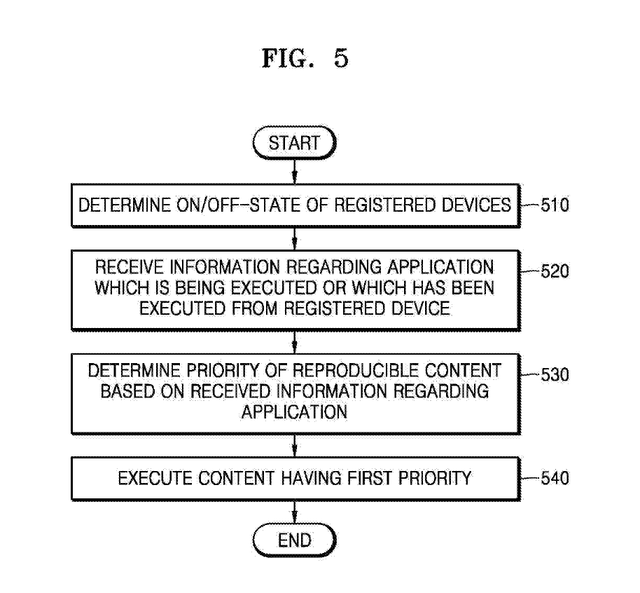

FIG. 5 is a flowchart for explaining a method of reproducing content seamlessly according to an embodiment. Referring to FIG. 5, the device 500 may detect the user's approach and reproduce content having a first priority.

In operation 510, the device 500 determines an on/off-state of registered devices.

In operation 520, the device 500 receives information regarding applications which are being executed or which have been executed from the registered devices. The device 500 may receive the information regarding the applications from the registered devices in an on-state.

In operation 530, the device 500 determines a priority of reproducible content based on the received information regarding the applications. Since an executable function is different depending on the device 500, the device 500 may determine whether there is reproducible content based on the information regarding the applications and determine a priority for only the reproducible content.

In operation 540, the device 500 executes content having a first priority. Therefore, the device 500 may reproduce content seamlessly even without a user's separate input. The device 500 may receive content determined as content having a first priority from a registered device. In other words, the device 500 may request the registered device which has reproduced previously the content having the first priority to transmit the content, and receive the content.

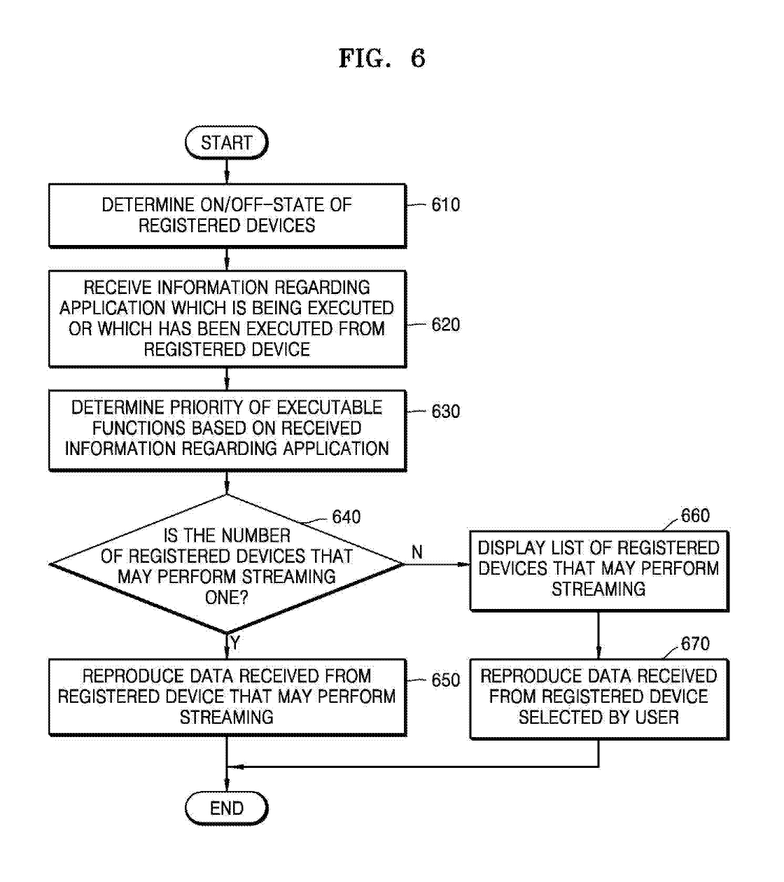

FIG. 6 is a flowchart for explaining a method of reproducing content seamlessly according to an embodiment. Referring to FIG. 6, the device 500 may detect that a user approaches and reproduce content having a first priority.

In operation 610, the device 500 determines an on/off-state of registered devices.

In operation 620, the device 500 receives information regarding applications which are being executed or which have been executed from the registered devices. The device 500 may receive the information regarding the applications from the registered devices in an on-state.

In operation 630, the device 500 determines a priority of reproducible content based on the received information regarding the applications. Since an executable function is different depending on the device 500, the device 500 may determine whether there is reproducible content based on the information regarding the applications and determine a priority for only the reproducible content.

In operation 640, the device 500 determines whether the number of registered devices that may perform streaming is one.

In operation 650, the device 500 reproduces data received from the registered device that may perform streaming. Since the number of registered devices that may perform streaming is one, the device 500 cannot receive data from other registered devices. Therefore, in the case where the number of registered devices that may perform streaming is one, the device 500 receives data from the registered device that may perform streaming and reproduces the received data.

In operation 660, the device 500 displays a list of the registered devices that may perform streaming. In the case where the registered devices that may perform streaming is two or more, since a registered device from which data is to be received should be determined, the device 500 displays the list of the registered devices that may perform streaming via the display unit 530.

In operation 670, the device 500 reproduces data received from a registered device selected by a user. The device 500 requests the registered device selected by the user to transmit the data, and reproduces the received data.

The device described herein may include a processor, a memory for storing and executing program data, a permanent storage unit such as a disk drive, a communications port for handling communications with external devices, and user interface devices, including a touch panel, keys, buttons, etc. When software modules or algorithms are involved, these software modules may be stored as program instructions or computer-readable codes executable on a processor on a computer-readable recording medium. Examples of the computer-readable recording medium include magnetic storage media (e.g., ROM, RAM, floppy disks, hard disks, etc.), and optical recording media (e.g., CD-ROMs, digital versatile disks (DVDs), etc.). The computer-readable recording medium can also be distributed over network coupled computer systems so that the computer-readable code is stored and executed in a distributive manner. This media can be read by the computer, stored in the memory, and executed by the processor.

The inventive concept may be described in terms of functional block components and various processing steps. Such functional blocks may be realized by any number of hardware and/or software components configured to perform the specified functions. For example, the inventive concept may employ various integrated circuit (IC) components, e.g., memory elements, processing elements, logic elements, look-up tables, and the like, which may carry out a variety of functions under the control of one or more microprocessors or other control devices. Similarly, where the elements of the inventive concept are implemented using software programming or software elements, the inventive concept may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the inventive concept could employ any number of conventional techniques for electronics configuration, signal processing and/or control, data processing and the like. The words “mechanism,” “element,” “means,” and “configuration” are used broadly and are not limited to mechanical or physical embodiments, but can include software routines in conjunction with processors, etc.

The particular implementations shown and described herein are illustrative examples of the inventive concept and are not intended to otherwise limit the scope of the inventive concept in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of the terms “a” and “an” and “the” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. The inventive concept is not limited to the described order of the steps. The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to one of ordinary skill in the art without departing from the spirit and scope of the inventive concept.

1. A method of reproducing content seamlessly, the method comprising:
determining an operation state of registered devices;
receiving information regarding an application which is being executed or which has been executed by a registered device in operation from among the registered devices;
determining a priority of reproducible content based on the information regarding the application; and
reproducing content having a first priority from among the content.

2. The method of claim 1, wherein the reproducing of the content comprises:
displaying a list of the reproducible content, and reproducing content selected by a user.

3. The method of claim 1, wherein the determining of the operation state comprises:
when a user approaches within a set range, determining an on/off-state of the registered devices.

4. The method of claim 1, wherein the determining of the priority comprises:
determining a priority of the content depending on a kind of the registered devices.

5. The method of claim 1, wherein the determining of the priority comprises:
determining a priority of the content depending on a kind of the application.

6. The method of claim 1, wherein the determining of the priority comprises:
determining a priority of the content depending on a kind of the content.

7. The method of claim 1, wherein the determining of the priority comprises:
determining a priority of the content by combining at least two or more of a kind of the registered devices, a kind of the application, a kind of the content, and a time when the application has been executed.

8. A device for reproducing content seamlessly, the device comprising:
a memory; and
a processor,
wherein the processor determines an operation state of registered devices, receives information regarding an application which is being executed or which has been executed by a registered device in operation from among the registered devices, determines a priority of reproducible content based on the information regarding the application, and reproduces content having a first priority from among the content.

9. The device of claim 8, wherein the processor displays a list of the reproducible content and reproduces content selected by a user.

10. The device of claim 8, wherein when a user approaches within a set range, the processor determines an on/off-state of the registered devices.

11. The device of claim 8, wherein the processor determines a priority of the content depending on a kind of the registered devices.

12. The device of claim 8, wherein the processor determines a priority of the content depending on a kind of the application.

13. The device of claim 8, wherein the processor determines a priority of the content depending on a kind of the content.

14. The device of claim 8, wherein the processor determines a priority of the content by combining at least two or more of a kind of the registered devices, a kind of the application, a kind of the content, and a time when the application has been executed.

15. A non-transitory computer-readable recoding medium having recorded thereon a program for executing the method of claim 1 on a computer.
